(19) United States
(12) Patent Application Publication
(10) Pub. No.: US 2026/0006697 A1
(43) Pub. Date: Jan. 1, 2026

(54) ELECTRONIC DEVICE

(71) Applicant: InnoLux Corporation, Chu-Nan (TW)

(72) Inventor: Ching-Yu CHENG, Chu-Nan (TW)

(21) Appl. No.: 19/219,495

(22) Filed: May 27, 2025

(30) Foreign Application Priority Data
Jun. 26, 2024 (CN) 202410835558.5

(51) Int. Cl. H05B 45/3725; H05B 45/10; H05B 45/325; H05B 45/46

(52) U.S. Cl. CPC H05B 45/3725; H05B 45/10; H05B 45/325; H05B 45/46

(57) ABSTRACT

An electronic device includes a power source, a light source and a driver. The power source includes a control signal end and an output end. The light source is electrically connected to the output end. The driver is electrically connected to the control signal end, and the driver includes: a signal source, and a signal conversion circuit. The signal conversion circuit is electrically connected to the signal source and the control signal end, wherein the signal conversion circuit includes a switch, the switch includes a control end, and the signal source is electrically connected to the control end of the switch.

### CROSS-REFERENCE TO RELATED APPLICATIONS

This application claims the benefits of the Chinese Patent Application Serial Number 2024108355585, filed on Jun. 26, 2024, the subject matter of which is incorporated herein by reference.

### BACKGROUND

### Field of the Disclosure

The present disclosure relates to an electronic device and, more particularly, to an electronic device capable of dynamically adjusting light source emission.

### Description of Related Art

In the backlight driving of using a light emitting diode device, such as a sub-millimeter light emitting diode (mini LED) or a micro light emitting diode (micro LED), as a light source, the design architecture has been gradually moved from using a light emitting diode driver with both functions of the light emitting diode power driving and the light emitting diode current balancing toward separately using a power control unit and a light emitting diode driver without power controller. However, with this architecture, since the light emitting diode driver and the power control unit are independent of each other, the feedback control method and control logic of the light emitting diode driver of each company's product are different, so that the peripheral parameters of feedback node for the connection of the power control unit and the light emitting diode driver have to be specially calculated and matched to meet the requirements of circuit operation, resulting in the problem of high customization of the power control unit, which is difficult to meet actual needs.

Therefore, it is desired to provide an improved electronic device to alleviate and/or obviate the above-mentioned problems.

### SUMMARY

The present disclosure provides an electronic device, which comprises: a power source including a control signal end and an output end; a light source electrically connected to the output end; and a driver electrically connected to the control signal end, and including: a signal source; and a signal conversion circuit electrically connected to the signal source and the control signal end, wherein the signal conversion circuit includes a switch, the switch includes a control end, and the signal source is electrically connected to the control end of the switch.

Other novel features of the disclosure will become more apparent from the following detailed description when taken in conjunction with the accompanying drawings.

### BRIEF DESCRIPTION OF DRAWINGS

FIG. 1 is a schematic diagram of the structure of an electronic device of the present disclosure;

FIG. 2 shows a curve representing the relationship between the control voltage and the output voltage of the power source according to the present disclosure;

FIG. 3 is a circuit diagram of the signal conversion circuit according to an embodiment of the present disclosure;

FIG. 4 is a circuit diagram of a signal conversion circuit according to another embodiment of the present disclosure;

FIG. 5 is a circuit diagram of a signal conversion circuit according to another embodiment of the present disclosure;

FIG. 6A shows an embodiment of the present disclosure for performing current balancing and dimming control on a light emitting diode unit;

FIG. 6B shows another embodiment of the present disclosure for performing current balancing and dimming control on a light emitting diode unit;

FIG. 6C shows another embodiment of the present disclosure for performing current balancing and dimming control on a light emitting diode unit;

FIG. 6D shows another embodiment of the present disclosure for performing current balancing and dimming control on a light emitting diode unit;

FIG. 6E shows another embodiment of the present disclosure for performing current balancing and dimming control on a light emitting diode unit; and

FIG. 6F shows another embodiment of the present disclosure for performing current balancing and dimming control on a light emitting diode unit.

### DETAILED DESCRIPTION OF EMBODIMENT

The implementation of the present disclosure is illustrated by specific embodiments to enable persons skilled in the art to easily understand the other advantages and effects of the present disclosure by referring to the disclosure contained therein. The present disclosure is implemented or applied by other different, specific embodiments. Various modifications and changes can be made in accordance with different viewpoints and applications to details disclosed herein without departing from the spirit of the present disclosure.

It should be noted that, in the specification and claims, unless otherwise specified, having “one” element is not limited to having a single said element, but one or more said elements may be provided. Furthermore, in the specification and claims, unless otherwise specified, ordinal numbers, such as “first”, “second”, etc., used herein are intended to distinguish elements rather than disclose explicitly or implicitly that names of the elements bear the wording of the ordinal numbers. The ordinal numbers do not imply what order an element and another element are in terms of space, time or steps of a manufacturing method.

In the entire specification and the appended claims of the present disclosure, certain words are used to refer to specific components. Those skilled in the art should understand that electronic device manufacturers may refer to the same components by different names. The present disclosure does not intend to distinguish those components with the same function but different names. In the claims and the following description, the words “comprise”, “include” and “have” are open type language, and thus they should be interpreted as meaning “including but not limited to”. Therefore, when the terms “comprise”, “include” and/or “have” are used in the description of the present disclosure, they specify the existence of corresponding features, regions, steps, operations and/or components, but do not exclude the existence of one or more corresponding features, regions, steps, operations and/or components.

In the description, the terms “almost”, “about”, “approximately” or “substantially” usually means within 10%, 5%, 3%, 2%, 1% or 0.5% of a given value or range. The quantity given here is an approximate quantity; that is, without specifying “almost”, “about”, “approximately” or “substantially”, it can still imply the meaning of “almost”, “about”, “approximately” or “substantially”. In addition, the term “range of the first value to the second value” or “range between the first value and the second value” indicates that the range includes the first value, the second value, and other values between the first and second values.

Unless otherwise defined, all terms (including technical and scientific terms) used here have the same meanings as commonly understood by those skilled in the art of the present disclosure. It is understandable that these terms, such as those defined in commonly used dictionaries, should be interpreted as having a meaning consistent with the relevant technology and the background or context of the present disclosure, rather than in an idealized or excessively formal interpretation, unless specifically defined.

In addition, relative terms such as “below” or “bottom”, and “above” or “top” may be used in the embodiments to describe the relationship between one component and another component in the drawing. It can be understood that, if the device in the drawing is turned upside down, the components described on the “lower” side will become the components on the “upper” side. When the corresponding member (such as a film or region) is described as “on another member”, it may be directly on the other member, or there may be other members between the two members. On the other hand, when a member is described as “directly on another member”, there is no member between the two members. In addition, when a member is described as “on another member”, the two members have a vertical relationship in the top view direction, and this member may be above or below the other member, while the vertical relationship depends on the orientation of the device.

In the present disclosure, the measurement method of thickness may be obtained by using an optical microscope, and the thickness may be obtained by measuring the cross-sectional image in an electron microscope, but it is not limited thereto. In addition, any two values or directions used for comparison may have certain errors. If the first value is equal to the second value, it implies that there may be an error of about 10% between the first value and the second value. If the first direction is perpendicular to the second direction, the angle between the first direction and the second direction may be in a range of 80 to 100 degrees. If the first direction is parallel to the second direction, the angle between the first direction and the second direction may be in a range of 0 to 10 degrees.

In the present disclosure, the electronic device may include a display device, a light source device, a backlight device, an antenna device, a sensing device or a tiled device, but it is not limited thereto. The electronic device may be a bendable or flexible electronic device. The display device may be a non-self-luminous display device or a self-luminous display device. The antenna device may be a liquid crystal type antenna device or a non-liquid crystal type antenna device, and the sensing device may be a sensing device for sensing capacitance, light, thermal energy or ultrasonic waves, but it is not limited thereto. Electronic components may include passive components and active components, such as capacitors, resistors, inductors, diodes, transistors, and the like. The diodes may include light emitting diodes or photodiodes. The light emitting diodes may, for example, include organic light emitting diodes (OLEDs), sub-millimeter light emitting diodes (mini LEDs), micro light emitting diodes (micro LEDs) or quantum dot light emitting diodes (quantum dot LEDs), but it is not limited thereto. The tiled device may be, for example, a display tiled device or an antenna tiled device, but it is not limited thereto. It should be noted that the electronic device may be any permutation and combination of the aforementioned, but it is not limited thereto.

It should be noted that the technical solutions provided in different embodiments below may be replaced, combined or mixed to form another embodiment without violating the spirit of the present disclosure.

Please refer to FIG. 1, which is a schematic diagram of the structure of an electronic device 1 of the present disclosure. The electronic device 1 is exemplified by a light emitting diode light source device. The electronic device 1 includes a power source 11, a light source 13, and a driver 15. The power source 11 includes a control signal end PV and an output end OT. The light source 13 is electrically connected to the output end OT of the power source 11. The driver 15 is electrically connected to the control signal end PV of the power source 11. The driver 15 includes a signal conversion circuit 155 and a signal source 153. The signal conversion circuit 155 is electrically connected to the signal source 153 and the control signal end PV of the power source 11. The signal source 153 is electrically connected to a light emitting diode driving circuit 151, or is part of the light emitting diode driving circuit 151.

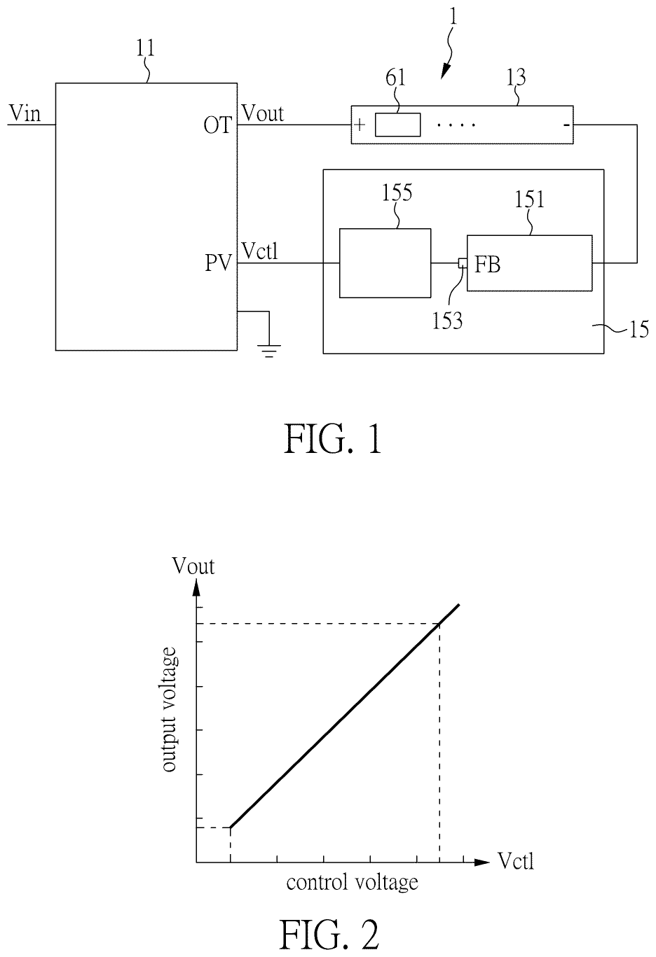

The power source 11 may be a power supply unit (PSU). The power source 11 may be electrically connected to an external voltage Vin provided by an external power supply, and may be electrically connected to an external voltage adjustment pin (PV pin) for use as a control signal end PV. The power supply unit may generate an output voltage Vout at the output end OT according to the control voltage Vct1 input to the control signal end PV, wherein the relationship between the control voltage Vct1 input to the control signal end PV and the output voltage Vout output from the output end OT may be the curve as shown in FIG. 2, which is a positive control logic. That is, the relationship between the control voltage Vct1 input to the control signal end PV and the output voltage Vout output from the output end OT is linear; for example, but not limited to, the control voltage Vct1 is proportional to the output voltage Vout, or the ratio of the control voltage Vct1 to the output voltage Vout is a constant value. As a result, also with reference to FIG. 1, the electronic device 1 of the present disclosure may use a feedback function pin (FB function pin) of the light emitting diode driving circuit 151 as the signal source 153, and the signal conversion circuit 155 is used to convert the disturbance signal output by the signal source 153 (that is, the feedback function pin FB) into the control voltage Vct1 for the power source 11, and the control voltage Vct1 is connected to the control signal end PV of the power source 11, thereby performing dynamic control on the output voltage Vout generated on the output end OT of the power source 11 by connecting the control voltage Vct1 to the control signal end PV of the power source 11.

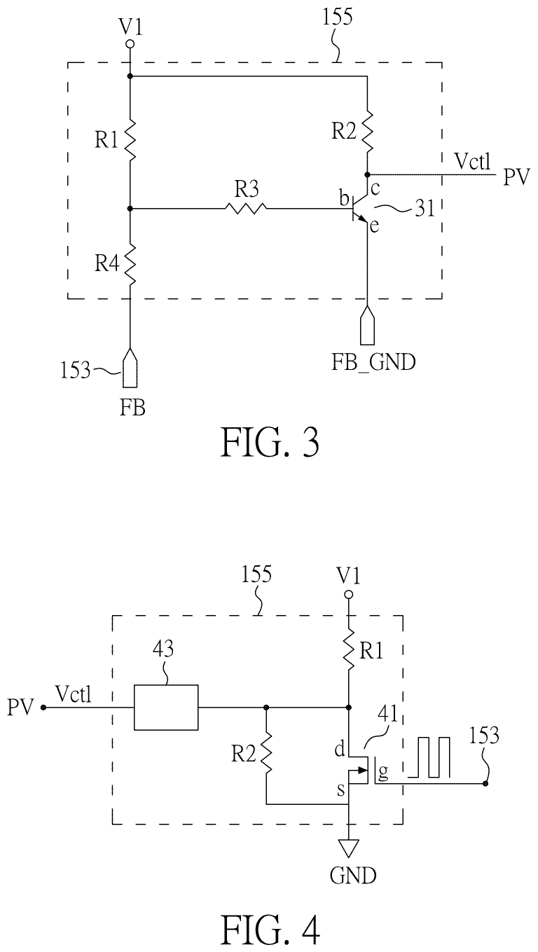

FIG. 3 is a circuit diagram of the signal conversion circuit 155 according to an embodiment of the present disclosure, which is suitable for converting a resistor-type disturbance signal. More specifically, the signal conversion circuit 155 may include, for example, a switch 31, a first resistor R1, a second resistor R2, a third resistor R3 and a fourth resistor R4. The switch 31 may be, for example, a bipolar junction transistor (BJT), and has a control end (b), a first connection end (e) and a second connection end (c). The control end (b), the first connection end (e) and the second connection end (c) are, for example, the base, emitter and collector of the bipolar junction transistor. The control end (b) of the switch 31 is connected to one end of the third resistor R3, the first connection end (e) of the switch 31 is connected to ground (FB_GND), and the second connection end (c) of the switch 31 is connected to one end of the second resistor R2 and then to the control signal end PV of the power source 11. One end of the first resistor R1 is connected to the other end of the second resistor R2 and further connected to a supply voltage V1. One end of the fourth resistor R4 is connected to the other end of the third resistor R3 and the other end of the first resistor R1. The other end of the fourth resistor R4 is connected to the signal source 153. Since the signal source 153 represents a resistor-type disturbance signal, the signal source 153 may be regarded as a variable resistor with a variable resistance value. Therefore, after being electrically connected to the variable resistor, the signal conversion circuit 155 forms a circuit affected by the disturbance signal. In the circuit structure of the signal conversion circuit 155 added with the variable resistor, since the signal source 153 is electrically connected to the control end (b) of the switch 31 through the resistor R4 and resistor R3, the switch 31 may operate in response to the signal source 153. The voltage value of the control voltage Vct1 may be changed with the resistor-type disturbance signal of the signal source 153 for being input to the control signal end PV of the power source 11 to control the output voltage Vout generated by the output end OT. It should be noted that, in the present disclosure, the supply voltage V1 may be a stably output voltage, and its voltage value may be determined according to actual needs, such as 5V, 3V or 12V.

FIG. 4 is a circuit diagram of a signal conversion circuit 155 according to another embodiment of the present disclosure, which is suitable for converting a PWM-type disturbance signal. The signal conversion circuit 155 includes a switch 41, a first resistor R1, a second resistor R2 and a digital-to-analog circuit 43. The switch 41 is, for example, a metal oxide semiconductor field effect transistor (MOSFET), and has a control end (g), a first connection end(s) and a second connection end (d). The control end (g), the first connection end(s) and the second connection end (d) are, for example, a gate, a source and a drain of a metal oxide semiconductor transistor, respectively. The control end (g) of the switch 41 is connected to the signal source 153, and the signal source 153 provides a PWM signal. The first connection end(s) of the switch 41 is connected to one end of the second resistor R2 and then to the ground (GND). The second connection end (d) of the switch 41, one end of the first resistor R1 and the other end of the second resistor R2 are connected, and further connected to one end of the digital-to-analog circuit 43. The other end of the first resistor R1 is connected to a supply voltage V1, and the other end of the digital-to-analog circuit 43 is connected to the control signal end PV of the power source 11, wherein the digital-to-analog circuit 43 is, for example but not limited to, a resistor-capacitor filter (RC filter) for converting digital signals into analog signals through RC filtering. In the circuit structure of the aforementioned signal conversion circuit 155, since the PWM-type disturbance signal of the signal source 153 may be transmitted to the control end (g) of the switch 41, the switch 41 may be operated in response to the signal source 153, so that the voltage value of the control voltage Vct1 may be changed with the PWM-type disturbance signal of the signal source 153 for being input to the control signal end PV of the power source to control the output voltage Vout generated by the output end OT.

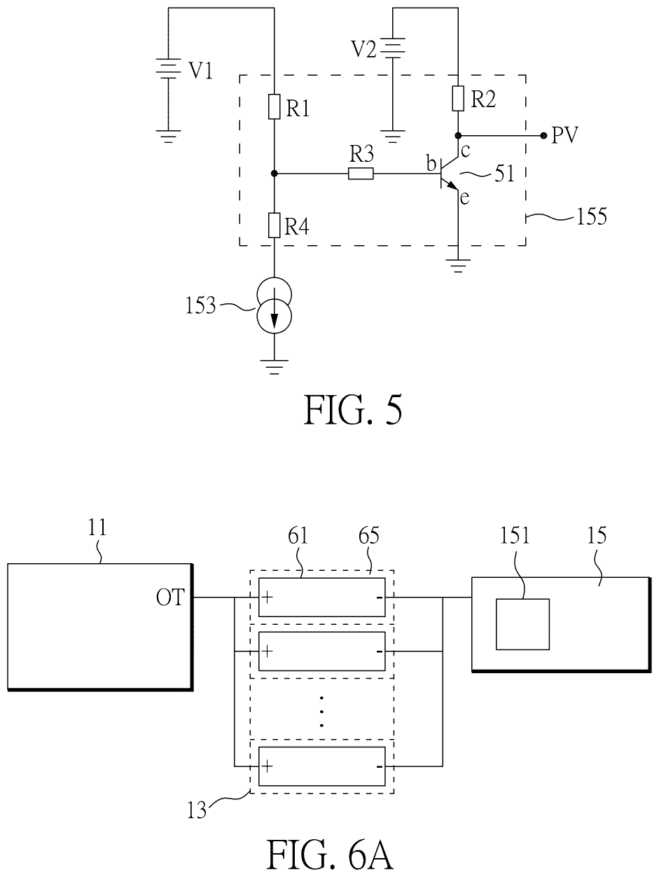

FIG. 5 is a circuit diagram of a signal conversion circuit 155 according to another embodiment of the present disclosure, which is suitable for converting a current-type disturbance signal. Similar to the embodiment shown in FIG. 3, the signal conversion circuit 155 includes a switch 51, a first resistor R1, a second resistor R2, a third resistor R3 and a fourth resistor R4. The switch 51 is, for example, a bipolar junction transistor (BJT), and has a control end (b), a connection end (e) and a second connection end (c), wherein the control end (b), the first connection end (e) and the second connection end (c) are, for example, the base, emitter and collector of a bipolar junction transistor, respectively. The control end (b) of the switch 51 is connected to one end of the third resistor R3, the first connection end (e) of the switch 51 is connected to ground, and the second connection end (c) of the switch 51 is connected to one end of the second resistor R2 and further connected to the control signal end PV of the power source 11. The other end of the second resistor R2 is connected to a second supply voltage V2, one end of the first resistor R1, the other end of the third resistor R3 and one end of the fourth resistor R4 are connected, the other end of the first resistor R1 is connected to a first supply voltage V1, and the other end of the fourth resistor R4 is connected to the signal source 153. This embodiment is different from the embodiment shown in FIG. 3 mainly in that the signal source 153 provides a current signal. In the circuit structure of the aforementioned signal conversion circuit 155, since the signal source 153 is electrically connected to the control end (b) of the switch 51 through the resistors (R4, R3), the current-type disturbance signal may be transmitted to the control end (b) of the switch 51, and thus the switch 51 may be operated in response to the signal source 153, so that the current-type disturbance signal of the signal source 153 may be converted into a control voltage Vct1 for being input to the control signal end PV of the power source 11 to control the output voltage Vout generated by the output end OT. It should be noted that, although one end of the second resistor R2 is connected to a second supply voltage V2 in FIG. 5, in some embodiments, one end of the second resistor R2 may also be connected to the first supply voltage V1. In short, in spite of the type of the disturbance signal provided by the signal source 153, a variable factor is provided, and the signal conversion circuit 155 matched with the variable factor may convert the stable supply voltages V1 and V2 into control voltage Vct1 according to the variable factor.

Furthermore, with reference to FIG. 1, the light source 13 is electrically connected to the output end OT of the power source 11 with its positive end (+) to obtain power supply to emit light, and is electrically connected to the light emitting diode with its negative end (−) to perform current balancing and dimming control. The light source 13 includes at least one light emitting diode (LED) unit 61, wherein the plurality of light emitting diode units 61 may be further configured to be connected in series, in parallel, or in series and in parallel, and the driver 15 of the present disclosure is used to achieve current balancing and dimming control for the light emitting diode units 61. The light emitting diode unit 61 is, for example but not limited to, a dot light source (such as a light emitting diode bulb), a linear light source (such as a light emitting diode strip) and a planar light source formed by organic light emitting diodes (OLEDs), sub-millimeter light emitting diodes (mini LEDs), micro light emitting diodes (micro LEDs) or quantum dot light emitting diodes (quantum dot LEDs).

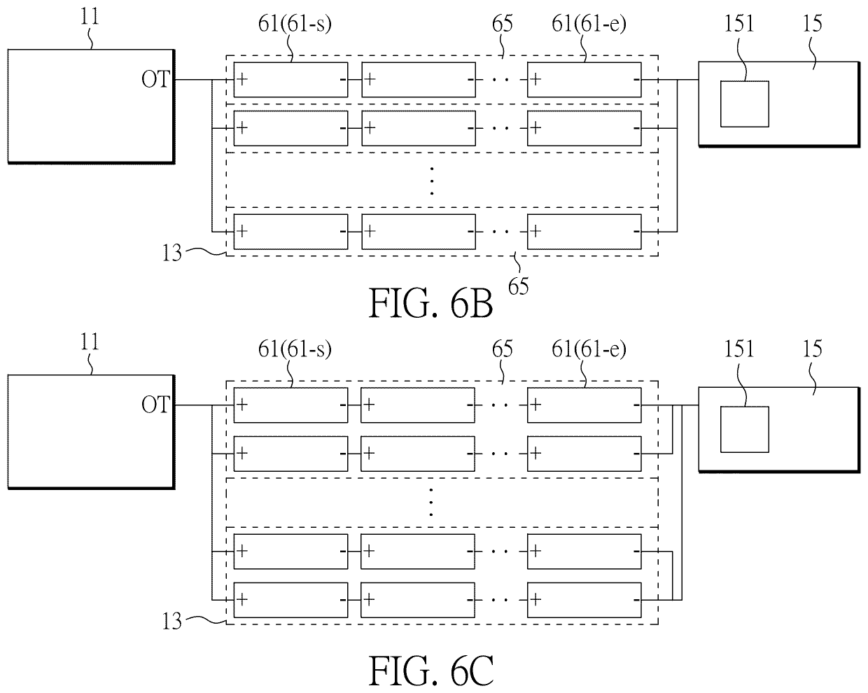

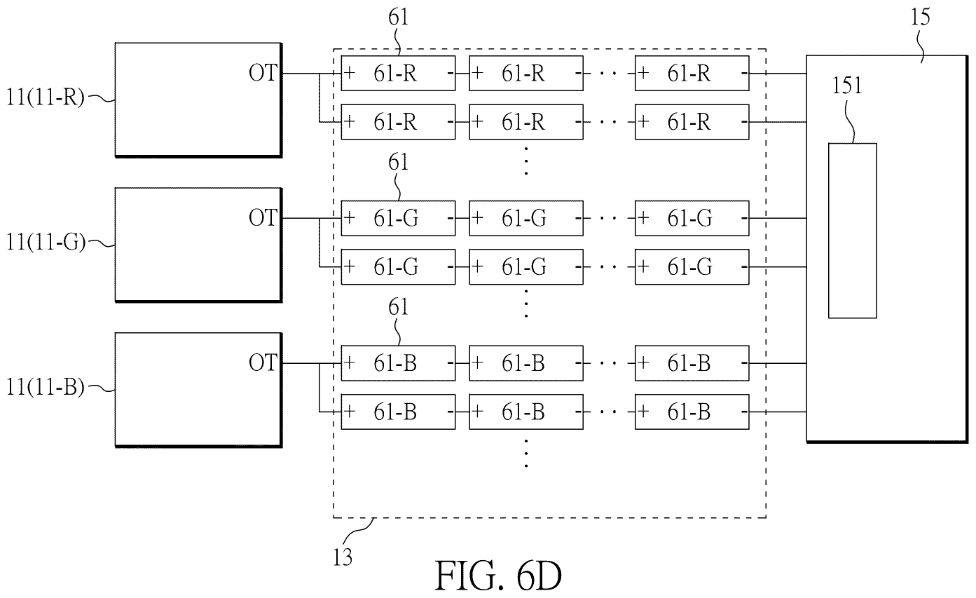

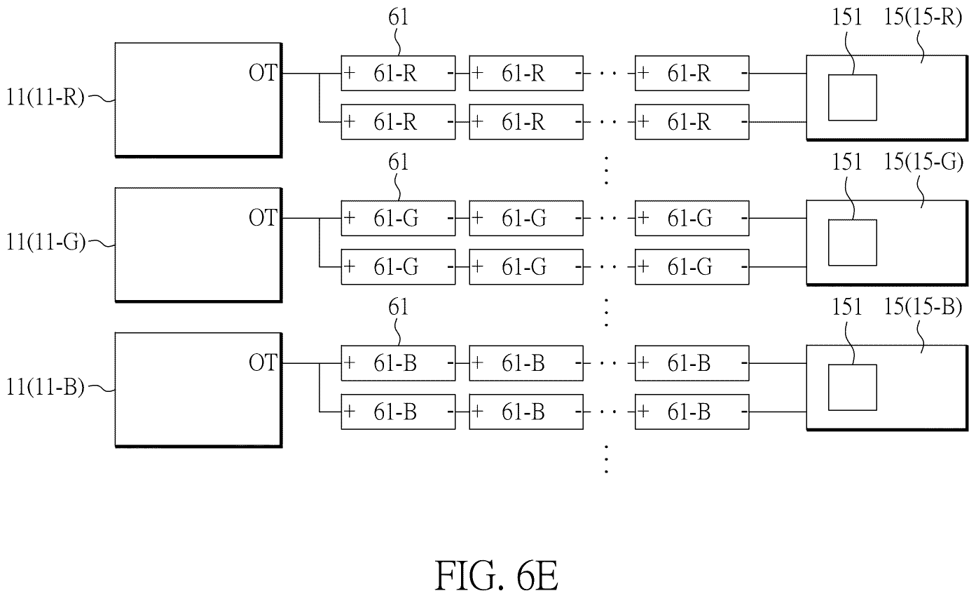

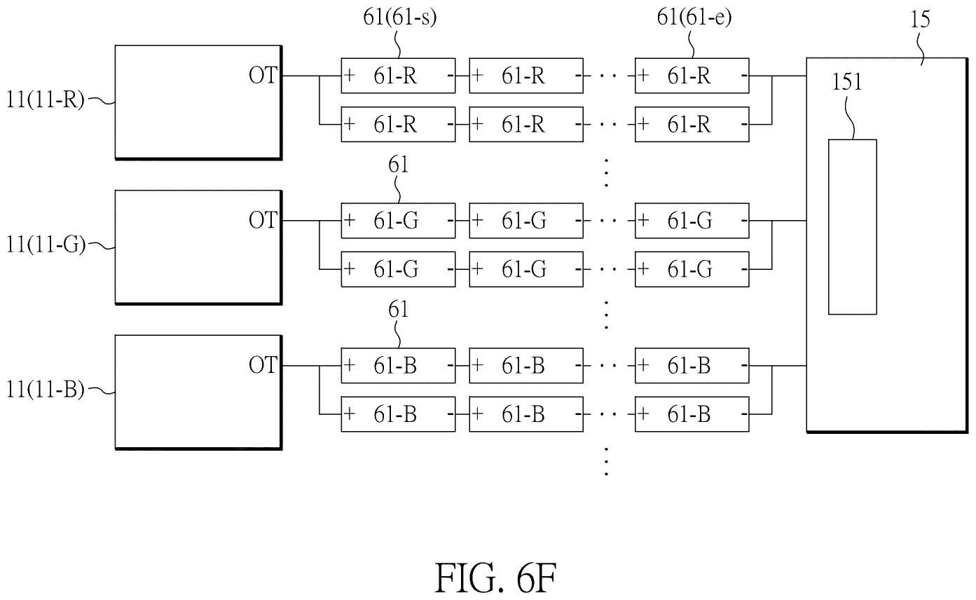

FIG. 6A shows an embodiment of the present disclosure for performing current balancing and dimming control on a light emitting diode unit 61, wherein the light source 13 includes at least one light emitting diode unit 61, and the first end (that is, the positive end (+)) and the second end (that is, the negative end (−)) of the light emitting diode unit 61 are electrically connected to the output end OT of the power source 11 and the light emitting diode driving circuit 151 of the driver 15, respectively. In this embodiment, as shown, the light source 13 may be divided into a plurality of regions 65 for performing current balancing and dimming control. Each region 65 has a light emitting diode unit 61. The positive ends (+) of all the light emitting units 61 are electrically connected to the output end OT of the power source 11 so as to use the same power source 11 for power supply, and the negative ends (−) of all the light emitting units 61 are electrically connected to the light emitting driving circuit 151 of the driver 15 so as to use the same driver 15 to drive and emit light, thereby performing current balancing and dimming control on the plurality of light emitting diode units 61.

FIG. 6B shows another embodiment of the present disclosure for performing current balancing and dimming control on the light emitting unit 61, wherein the light source 13 includes a plurality of LED units 61 connected in series to form at least one light emitting string, and the first end (that is, the positive end (+)) of the first light emitting diode unit 61-s and the second end (that is, the negative end (+)) of the last light emitting diode unit 61-e of the light emitting diode string are electrically connected to the output end OT of the power source 11 and the light emitting diode driving circuit 151 of the driver 15, respectively. In this embodiment, as shown, the light source 13 may be divided into a plurality of regions 65 for performing current balancing and dimming control. Each region 65 has a plurality of light emitting diode units 61 connected in series to form a light emitting diode string. The positive end (+) of the first light emitting diode unit 61-s of the light emitting diode string in each region 65 is connected to the output end OT of the power source 11 so as to use the same power source 11 for power supply, and the negative end (−) of the last light emitting diode unit 61-e of the light emitting diode string in each region 65 is connected to the light emitting diode driving circuit 151 of the driver 15 so as to use the same driver 15 to drive and emitting light, thereby performing current balancing and dimming control on the plurality of light emitting diode units 61.

FIG. 6C shows another embodiment of the present disclosure for performing current balancing and dimming control on the light emitting diode unit 61, wherein, similar to the embodiment of FIG. 6B, the light source 13 includes a plurality of light emitting diode units 61 connected in series to form at least one light emitting string, and the light source 13 may be divided into a plurality of regions 65 for performing current balancing and dimming control. In this embodiment, as shown, each region 65 has a plurality of light emitting diode units 61 connected in series to form a plurality of light emitting diode strings. FIG. 6C shows that each region 65 has two light emitting strings, while this is only an example but not a limitation. The positive ends (+) of the first light emitting units 61-s of the plurality of light emitting diode strings in each region 65 are all connected to the output end OT of the power source 11 so as to use the same power source 11 for power supply, and the plurality of light emitting diode strings in each region 65 are connected in parallel by making the negative ends (−) of the last light emitting diode units 61-e connected together and then connected to the light emitting diode driving circuit 151 of the driver 15 so as to use the same driver 15 to drive and emit light, thereby performing current balancing and dimming control on the plurality of light emitting diodes 61.

FIG. 6D shows another embodiment of the present disclosure for performing current balancing and dimming control on the light emitting diode unit 61, wherein the light emitting diode units 61 include red light emitting diode units 61-R, green light emitting diode units 61-D, and green light emitting diode units 61-E. Because the light emitting diode units 61-R, 61-G, 61-B of different colors may have different internal reference voltages, the light emitting diode units 61-R, 61-G, 61-B of different colors are powered by different power sources 11-R, 11-G, 11-B, respectively, and may still use the same driver 15 to drive and emit light. In this embodiment, the configuration of each color of the light emitting diode units 61-R, 61-G, 61-B in the light source 13 is the same as that of the embodiment of FIG. 6B, and thus a detailed description is deemed unnecessary. It should also be noted that the two strings of light emitting diode units 61-R, the two strings of green light emitting diode units 61-G, and the two strings of blue light emitting diode units 61-B shown in FIG. 6D are only for illustrative purpose and, in other embodiments, the number of strings of light emitting diodes of different colors may be one string, three strings, or more than three strings. Furthermore, in some embodiments, the number of strings of light emitting diodes of different colors may be the same or different depending on actual design requirements. In addition, in the present disclosure, the number of light emitting diodes in each light emitting diode string may be the same or different.

FIG. 6E shows another embodiment of the present disclosure for performing current balancing and dimming control on the light emitting diode unit 61, wherein the configuration of the light emitting diode units 61 in this embodiment is similar to the embodiment of FIG. 6D, except that the light emitting diode units 61-R, 61-G, 61-B of different colors are driven by different drivers 15-R, 15-G, 15-B respectively to emit light. The description of performing current balancing and dimming control on the plurality of light emitting diode units 61 is also applicable to the embodiment of FIG. 6D, and thus a detailed description is deemed unnecessary.

FIG. 6F shows another embodiment of the present disclosure for performing current balancing and dimming control on the light emitting diode unit 61, wherein the configuration of the light emitting diode units 61 in this embodiment is similar to the embodiment of FIG. 6D, except that the light emitting diode units 61-R, 61-G, 61-B of each color are connected in series to form at least one light emitting diode string, and the plurality of light emitting diode strings of the same color are connected in parallel by making the negative ends (−) of the last light emitting diode units 61-e connected together and then connected to the light emitting diode driving circuit 151 of the driver 15 so as to use the same driver 15 to drive and emit light. The description of performing current balancing and dimming control on the plurality of light emitting diode units 61 is also applicable to the embodiment of FIG. 6D, and thus a detailed description is deemed unnecessary.

As can be seen from the above description, the electronic device of the present disclosure makes use of the feedback function pin provided by the light emitting diode driving circuit to convert various types of disturbance signals from the signal source into control voltages for the power supply through the signal conversion circuit and for connection to the voltage adjustment function pin of the power supply unit so as to control the output voltage. Since this control does not directly disturb the feedback reference node of the power supply unit, and the control voltage signal and the output voltage are in a relationship of positive control logic, it is able to quickly and easily achieve dynamic adjustment of light emitting of the light source.

The features of the various embodiments of the present disclosure may be mixed and matched as long as they do not violate the spirit of the disclosure or conflict with each other.

The aforementioned specific embodiments should be construed as merely illustrative, and not limiting the rest of the present disclosure in any way.

1. An electronic device, comprising:
a power source including a control signal end and an output end;
a light source electrically connected to the output end; and
a driver electrically connected to the control signal end, and including:
a signal source; and
a signal conversion circuit electrically connected to the signal source and the control signal end,
wherein the signal conversion circuit includes a switch, the switch includes a control end, and the signal source is electrically connected to the control end of the switch.

2. The electronic device as claimed in claim 1, wherein the switch is a metal oxide semiconductor field effect transistor.

3. The electronic device as claimed in claim 1, wherein the switch is a bipolar junction transistor.

4. The electronic device as claimed in claim 1, wherein the signal source provides a PWM signal to the control end of the switch of the signal conversion circuit.

5. The electronic device as claimed in claim 1, wherein the signal source provides a current signal to the control end of the switch of the signal conversion circuit.

6. The electronic device as claimed in claim 1, wherein the signal conversion circuit includes a digital-to-analog circuit.

7. The electronic device as claimed in claim 1, wherein there is a linear relationship between a control voltage input to the control signal end and an output voltage output from the output end.

8. The electronic device as claimed in claim 1, wherein the driver further includes a light emitting diode driving circuit, and the light emitting diode driving circuit is electrically connected to the signal source.

9. The electronic device as claimed in claim 8, wherein the light source includes at least one light emitting diode unit, the output end is electrically connected to a first end of the light emitting diode unit, and the light emitting diode driving circuit is electrically connected to a second end of the light emitting diode unit.

10. The electronic device as claimed in claim 8, wherein the light source includes a plurality of light emitting diode units connected in series to form at least one light emitting diode string, the output end is electrically connected to a first end of a first light emitting diode in the light emitting diode string, and the light emitting diode driving circuit is electrically connected to a second end of a last light emitting diode unit in the light emitting string.

11. The electronic device as claimed in claim 3, wherein the signal conversion circuit further includes a first resistor, a second resistor, a third resistor and a fourth resistor, the control end of the switch is connected to one end of the third resistor, a first connection end of the switch is connected to ground, a second connection end of the switch and one end of the second resistor are connected and then connected to the signal control signal end of the power source, one end of the first resistor is connected to another end of the second resistor and is further connected to a first supply voltage, one end of the fourth resistor is connected to another end of the third resistor and another end of the first resistor, and another end of the fourth resistor is connected to the signal source.

12. The electronic device as claimed in claim 11, wherein the control end, the first connection end and the second connection end of the switch are a base, an emitter and a collector of the bipolar junction transistor, respectively.

13. The electronic device as claimed in claim 6, wherein the signal conversion circuit further includes a first resistor and a second resistor, a first connection end of the switch is connected to one end of the second resistor and is further connected to ground, a second connection end of the switch, one end of the first resistor and another end of the second resistor are connected and then connected to one end of the digital-to-analog circuit, another end of the first resistor is connected to a first supply voltage, and another end of the digital-to-analog circuit is connected to the control signal end of the power source.

14. The electronic device as claimed in claim 13, wherein the control end, the first connection end and the second connection end of the switch are a gate, a source and a drain of the metal oxide semiconductor field effect transistor, respectively.

15. The electronic device as claimed in claim 13, wherein the digital-to-analog circuit is a resistor-capacitor filter.

16. The electronic device as claimed in claim 5, wherein the signal conversion circuit further includes a first resistor, a second resistor, a third resistor and a fourth resistor, the control end of the switch is connected to one end of the third resistor, a first connection end of the switch is connected to ground, a second connection end of the switch and one end of the second resistor are connected and then connected the control signal end of the power source; another end of the second resistor is connected to a second supply voltage, one end of the first resistor, another end of the third resistor and one end of the fourth resistor are connected, another end of the first resistor is connected to a first supply voltage, and another end of the fourth resistor is connected to the signal source.

17. The electronic device as claimed in claim 16, wherein the control end, the first connection end and the second connection end of the switch are a base, an emitter and a collector of the bipolar junction transistor, respectively.

18. The electronic device as claimed in claim 1, wherein the driver further includes a light emitting diode driving circuit, and the signal source is a feedback function pin of the light emitting diode driving circuit.

19. The electronic device as claimed in claim 1, wherein the power source is a power supply unit and is electrically connected to an external voltage provided by an external power supply, and the control signal end is an external voltage adjustment function pin of the power supply unit.

20. The electronic device as claimed in claim 8, wherein the light source includes a plurality of light emitting diode units connected in series to form at least one light emitting diode string, and the light source is divided into a plurality of regions, each region having a plurality of light emitting diode units connected in series to form a plurality of light emitting diode strings.
